(19) United States
(12) Patent Application Publication
(10) Pub. No.: US 2003/0132406 A1
(43) Pub. Date: Jul. 17, 2003

(54) Sensor element for optically detecting chemical or biochemical analytes

(76) Inventors: Ralf Waldhausl, Jena (DE); Norbert Danz, Jena (DE)

Correspondence Address: Andrew R Basile, Young & Basile, Suite 624, 3001 West Big Beaver Road, Troy, MI, 48084, US

(21) Appl. No.: 10/221,588

(22) PCT Filed: Feb. 16, 2001
(86) PCT No.: PCT/DE01/00672

(51) Int. Cl. G01N 21/49; G01N 21/03

(52) U.S. Cl. 250/574; 422/82.05

(57) ABSTRACT

The invention relates to a sensor element for optically detecting chemical or biochemical analytes which may be contained in different samples. The object is to minimize the required sample volume and to allow the individual samples to be arranged relatively close together, while nevertheless achieving a high measurement accuracy. At least one interface, at which an evanescent field is formed as a result of total reflection, is formed on the sensor element. The samples are held in mutually separated cavities, and the cavities are formed inside a structured cover layer applied directly to a substrate. In this case, the layer thickness of the cover layer is at least greater than the penetration depth of the evanescent field. The cover layer consists of a fluorinated polymer, and it prevents substance exchange of the individual samples that are held in the various cavities.

The invention relates to sensor elements for optically detecting chemical or biochemical analytes which may be contained in different samples.

The detection of chemical or biochemical analytes may in this case be carried out by employing known physical effects, an evanescent field with a limited penetration depth being formed as a result of total reflection occurring at interfaces by using injected light. In the evanescent field, it is then possible to excite fluorescence in fluorophores, generate surface plasmon resonance (SPR) or interferometrically determine a wide variety of analytes.

The invention is especially suitable for evaluating a large number of differently prepared samples, as may be used with minimal sample volumes for screening methods introduced from pharmacological active-substance research. The miniaturization which can be achieved has a particularly advantageous effect in this case, which is especially suitable in relation to the microtitre plates customarily used previously, in which a limited number of so-called wells can be utilized.

A large number of different solutions are known for optically detecting chemical or even biochemical analytes. For instance, WO 94/27137 A2 describes a device and a method for carrying out fluorescence immunoassays, in which a plurality of analytes can be detected simultaneously.

In this solution, a planar, relatively large-area optical waveguide is generally used, into which excitation light is injected by means of a peripherally arranged optical element, and total reflection takes place at the interfaces of this planar optical waveguide, so that an evanescent field with a limited penetration depth is respectively formed at the other surface of the optical waveguide. Fluorescent light, whose intensity can be determined using optical detectors, is then excited in fluorophores inside the evanescent field. In this way, it is possible to determine the presence and the concentration of analytes using known assay formats (for example sandwich assay, competive assay).

With these relatively large-area, planar optical waveguides, however, an inhomogeneous distribution of the injected excitation light is to be observed, which leads to a correspondingly irregular formation of the evanescent field over the area of the planar optical waveguide. Accordingly, measurement errors occur when recording the intensity of the fluorescent light in a spatially resolved measurement.

It is furthermore proposed to use an optically suitable plastic as a support for individual samples arranged mutually separated. With such a plastic, however, it is not possible to use all the wavelength ranges of visible and invisible light, since the plastic materials are also susceptible to fluorescence or absorption in particular wavelength ranges.

Furthermore, the number of samples which can be studied on such an element is limited, since mutual perturbation of the fluorescent light to be measured occurs in the case of per se mutually separated fields if the individual samples are arranged too densely.

Further general requirements which of optical measurement systems for detecting chemical or biochemical analytes, with the relevant optical features, will be listed in a general form below.

The basic requirement is to separate the individual, generally different samples, so that substance exchange of the different samples is prevented and the measurement signals of neighboring samples can be separated reliably from one another (optical channel separation).

In contrast to transmitted-light methods, in which the optical channel separation are separated from one another by means of optically absorbing walls, however, it is necessary to separate neighboring samples using optically transparent separating walls in the solution according to the invention.

Since perturbation of the light, for example scattering and reflection of excitation light, can take place at interfaces between neighboring samples if the media have different optical properties (for example refractive index differences), appropriate measures must be implemented and taken into account in order to substantially avoid any mutual perturbation.

The separating walls between neighboring samples should deliver no signal, or only a very small signal (for example no fluorescence), which is superimposed or perturbs the actual detection signal, in order to avoid measurement errors.

A further basic requirement is complete substance separation of the various samples to be detected, so that dispersion and mixing of the different samples can be avoided. To that end, a suitable material must be chemically inert, so that no chemical reactions can take place with the sample materials, and wetting with optionally used solvents should also not occur.

A practicable solution has not yet been proposed, with which a relatively large number of samples can be arranged on a relatively small area and the individual samples can be detected virtually unperturbed.

Said requirements can be achieved or satisfied only partially with structured immobilization of such samples by using hydrophobic long-chained molecules. When producing these immobilization structures, it is extremely difficult to ensure locally definite immobilization of the various samples. The chemical compatibility of the very different technology steps during application contributes to this. Adsorption may furthermore give rise, between individual samples, to the presence of molecules which perturb and falsify the measurement values of neighboring samples, and which therefore negate the optical channel separation.

It is therefore an object of the invention to provide a way in which a wide variety of chemical or biochemical analytes can be optically detected, with a sample volume that is as small as possible being achievable and a plurality of samples arranged relatively close together being detectable with a high measurement accuracy.

According to the invention, this object is achieved by a sensor element with the features of claim 1. Advantageous configurations and refinements of the invention can be achieved by the features mentioned in the dependent claims.

These also involve ways of producing a sensor element according to the invention, as well as ways of carrying out measurements with such sensor elements.

The sensor element according to the invention for optically detecting chemical or biochemical analytes, which are contained in the same or different samples, employs the known physical principle of forming an evanescent field by total reflection of injected light at an optical interface. The samples are to that end held in mutually separated cavities, the samples being arranged inside the evanescent field that is formed.

To that end, the sensor element is constructed in such a way that a structured cover layer, as far as possible in the configuration of a planar structure, is formed directly on a substrate, in which cover layer cavities that are mutually separated by the structuring, and in which the samples are held, are formed. In this case, the individual cavities are constrained by the cover-layer material in such a way that substance exchange between the individual samples is prevented, and the individual fluorescence signals are optically separated. The cover layer is advantageously formed from a material with a refractive index≦1.3. It may advantageously consist of fluorinated polymers (for example PTFE), and very advantageously of amorphous fluorinated polymers. The latter material is available, for example, under the brand name Teflon AF from the company Du Pont, and it is correspondingly described at length in company documentation.

Such a cover-layer material not only has particularly advantageous optical properties (low refractive index, good transmission), but it also has an extraordinary favorable wetting behavior.

However, the wetting behavior is a hindrance in terms of secure and permanent fastening to the substrate. Nevertheless, this disadvantage can be fully avoided, in particular, by using amorphous fluorinated polymers with an additional adhesion-promoter layer, which is to be applied to the substrate surface as a molecular layer immediately before applying the cover layer, so that the cover layer is formed fluid-tight on the substrate and substance exchange from various cavities into other cavities can be prevented.

The structuring to form the cavities in the cover layer formed on the substrate may in this case be carried out in such a way that the bottom of the individual cavities is formed directly by the substrate material. As an alternative, however, a certain layer thickness of the cover-layer material may be also present between the respective substrate surface and the bottom of the cavities, although in each case it is necessary to ensure that the samples are arranged at least partially inside the evanescent field that is formed.

The excitation light is introduced into at least one optical waveguide at whose interfaces total reflection occurs, and the optical waveguide/waveguides is/are arranged at least below the bottoms of the cavities. The optical waveguides may in this case be arranged on the surface of the substrate, although they may also be embedded in the substrate material.

The use of stripline optical waveguides, whose arrangement is matched to the arrangement of the cavities arranged in the structured cover layer, offers advantages. For instance, with a row arrangement of the cavities, a stripline optical waveguide may be arranged and used for each row of cavities. In this case, it is also possible to use light with different wavelengths for each stripline optical waveguide. Stripline optical waveguides have advantages over planar waveguides. They achieve a more uniform light distribution, and consequently form a more uniform evanescent field, so that the measurement errors can be reduced. Since more accurate allocation and better optical separation can be achieved, mutual perturbation of the measurement signals from the individual cavities is greatly reduced.

If optical waveguides are being used, then it is also possible to use substrate materials which are not transparent or absorbent. In this case, a sufficiently thick, non-absorbent and less refractive optical buffer layer is required between the substrate and the optical waveguide. Such a substrate material is, for example, silicon.

In a further variant, however, it is also possible to obviate optical waveguides per se, and to inject the excitation light into a substrate which is then transparent, with total reflection occurring at the substrate-cover layer interface, taking the refractive index into account, in order to generate an evanescent field.

The sensor element according to the invention is, as already mentioned in the introduction, not only suitable for carrying out fluorescence immune tests, but rather it is also possible to employ the physical effect of surface plasmon resonance (SPR). To that end, the optical waveguide/waveguides is coated in a manner that is known per se with a thin metal layer, for example of gold or silver. In this case, it is sufficient to provide the surface of the optical waveguides/waveguide in places with such a metal layer; the coating may be carried out by known thin-film methods, and coating of the optical waveguide surface should be carried out at least in the region of the cavities of the sensor element according to the invention. It is possible for regions extending further, that is to say ones which are arranged in the separating gaps between neighboring cavities, to be provided with a metal, so that reference signals can be obtained therefrom.

The detection of the fluorescence signals is always carried out above the openings of the cavities in the sensor elements according to the invention. To that end, one or more optical detectors may be arranged accordingly, although a spatially resolved measurement should be carried out in accordance with the respective cavity arrangements.

Other optical parameters are measured directly in the waveguide (for example SPR).

The measurement accuracy can be increased further by arranging an optically absorbing layer, or a plate of such a material, above the structured cover layer, or by placing it directly on the surface of the cover layer. Openings or optically transparent windows, whose arrangement corresponds to the arrangement of the cavities formed in the cover layer, are formed in this layer or plate, so that the light to be measured can emerge through these openings or windows, which then fulfill a diaphragm function, and can be measured using the detector(s).

As already mentioned, an amorphous fluorinated polymer with a refractive index of 1.29, which lies between the refractive indices of air and water, closer to the refractive index of water, has proved advantageous as a cover-layer material. In this way, it is possible for scattered-light losses to be avoided, or at least significantly reduced, during the measurements.

When producing the sensor elements according to the invention, it is possible to proceed in such a way that the cover layer is applied directly to a substrate which, for example, may consist of glass or plastic. However, it is also possible to use a wafer, for example of silicon, as the substrate. An optical waveguide, which is optionally also provided with a metal layer, may be applied to the substrate in situ, or it may be embedded in the substrate material, so that the cover layer is present above the regions in which one or more optical waveguides are formed or arranged.

The cover layer may be formed by conventional immersion methods, although it is preferably formed by spin coating, in which case the layer thickness can be influenced and adjusted by the spin-coater speed and the concentration of a solvent that is used. After application, the solvent is removed by an appropriate heat treatment, and the cover layer needs to be structured accordingly in order to form the desired cavities; the structuring may be produced by photolithographic methods known from microtechnology, which are used in conjunction with etches.

In this case, on the one hand, it is possible to proceed in such a way that a layer of photoresist is applied to the cover layer that has been applied, the photoresist is then photolithographically structured and the mask required for subsequent plasma-chemical etching is hence formed. In this case, the photoresist layer must have a sufficient thickness since the different etching rates of the materials that are used for the cover layer and the photoresist that is used need to be taken in account.

As an alternative, however, a thin metal layer may be deposited on the cover layer and then photolithographically structured by using a photoresist, and subsequently wet-chemically etched. In this way, a metal mask is obtained on the cover layer and plasma-chemical etching can then in turn be carried out. The metal is not attacked during the etching process, and can later be removed wet-chemically. The latter should be carried out in order minimize the wetting of surfaces on the cover layer by water or solvents.

The former variant for producing the sensor elements according to the invention requires fewer working steps since, in particular, it is not necessary to remove the metal layers. This is offset, however, by the attack of the photoresist during the etching and the poor adhesion of the photoresist to the fluorinated polymers.

With such photolithographically structuring of the cover layer, it is possible to achieve structure sizes as far as the sub-micrometer range, so that the cavities are arranged in a high-density form and a large number of samples can be arranged and measured next to one another on relatively small areas.

Planar technologies, which are known per se and with which miniaturized elements can be fabricated inexpensively in large numbers, may also be used for production.

It is advantageous to use substrate materials which have a relatively low etching rate compared with the other materials and, in particular, the cover-layer material, as is the case for example with silica. Such materials then function with their surface has a natural etch-stop. In this way, with a relatively low outlay during the plasma-chemical etching (for example oxygen-plasma etching), it is possible to ensure that the residual layer thickness of the cover layer at the bottom of the cavities is zero, or at least close to zero, so that the samples held in the cavities are arranged in the region of the evanescent field that is formed.

Furthermore, high-purity surfaces that promote immobilization can be obtained by such plasma treatment.

The sensor elements according to the invention, with the correspondingly formed structured cover layers, optimally fulfill the -requirements mentioned in the introduction to the description, since they do not admit any signals due to adsorbed analyte molecules or target molecules outside the cavities, and parts of the cover layer between cavities that are formed can be used to obtain reference signals, since the light emerging from the cover layer in these regions can also be detected and used for referencing. In this way, the measurement signals from samples that are held in neighboring cavities can be normalized by using the measurement signal which can obtained from the cover layer lying in between. Even with a relatively large number of cavities, and consequently also a large number of individual samples, it is thus possible to guarantee comparability of all the samples.

Illumination inhomogeneities and production inhomogeneities can thus be taken into account with the correspondingly obtained reference signals during the evanescent fluorescence excitation by means of total reflection. Such illumination inhomogeneities occur in all optical waveguides, including stripline optical waveguides, owing to absorption and scattering effects inside the waveguide, and they normally lead to losses. Furthermore, the absorption of excitation light for the detection of molecules also reduces the excitation energy. Both effects can be picked up with the sensor elements according to the invention, and taken into account during the evaluation of the measurement results.

When recording measurement values that can be directly assigned to a physical quantity, the cover-layer structuring can likewise be used for measurement-error compensation. For the system in question, a particular resonance angle in the case when surface plasmon resonance is being used, or the resonant wavelength in a spectral measurement, may depend on the refractive index of the cover-layer material on the respective metal layer. In this case, it is also necessary to take into account the layer thickness of the metal layer, which may in turn vary over the area for reasons due to production. This variation may also be taken into account through the aforementioned determination of reference measurement values beside the cavities.

The invention will be explained in more detail below with the aid of exemplary embodiments.

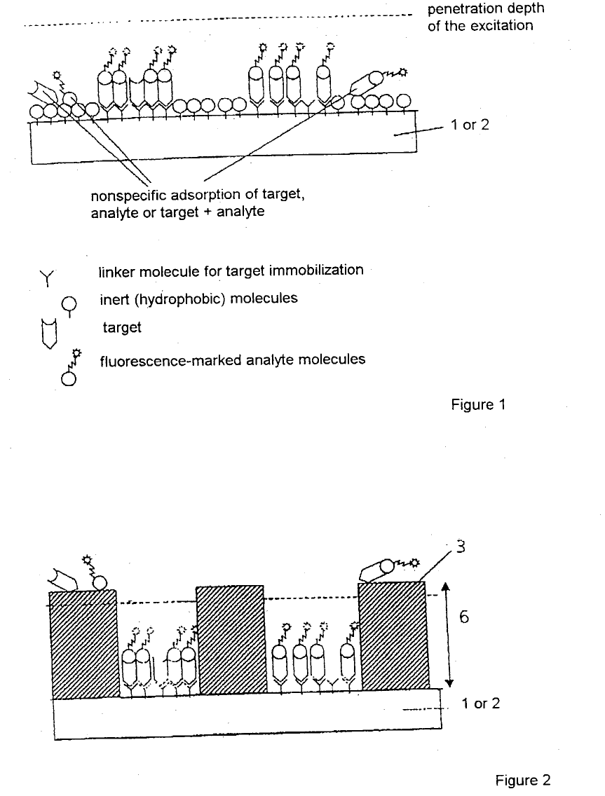

FIG. 1 shows, in a schematic form, an approach for structured immobilization;

FIG. 2 shows, in a schematic form, an approach for substance separation of different samples by means of a separating-wall material;

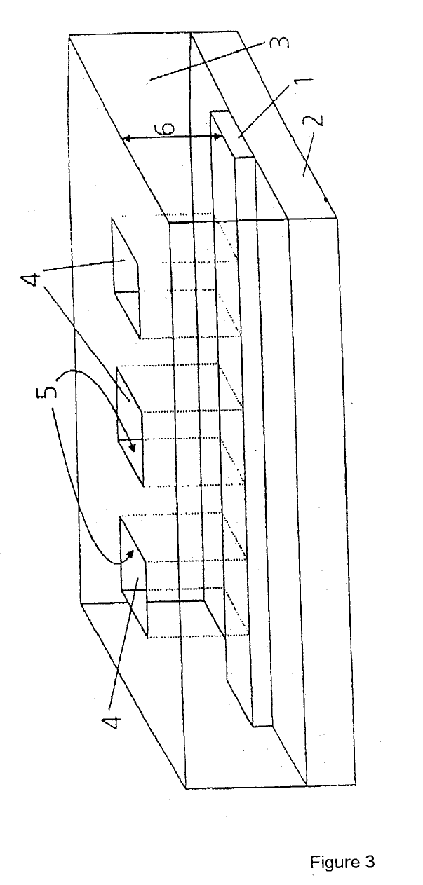

FIG. 3 shows an example of a sensor element according to the invention;

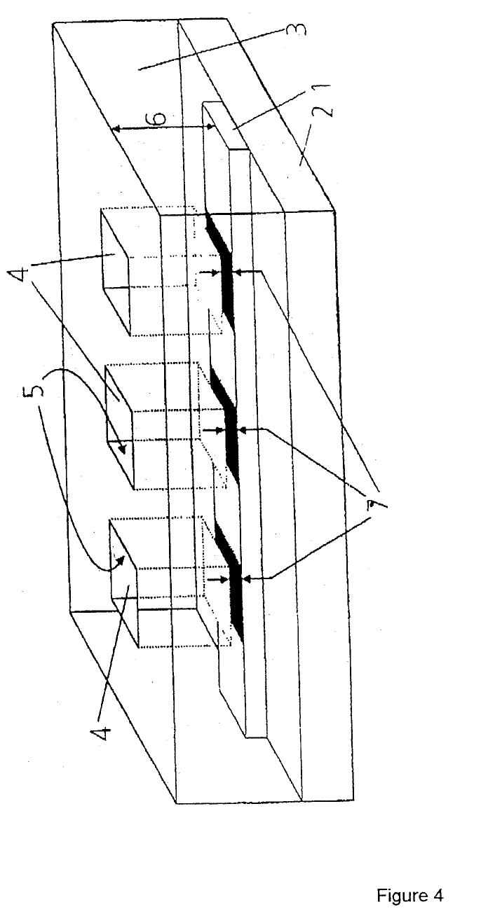

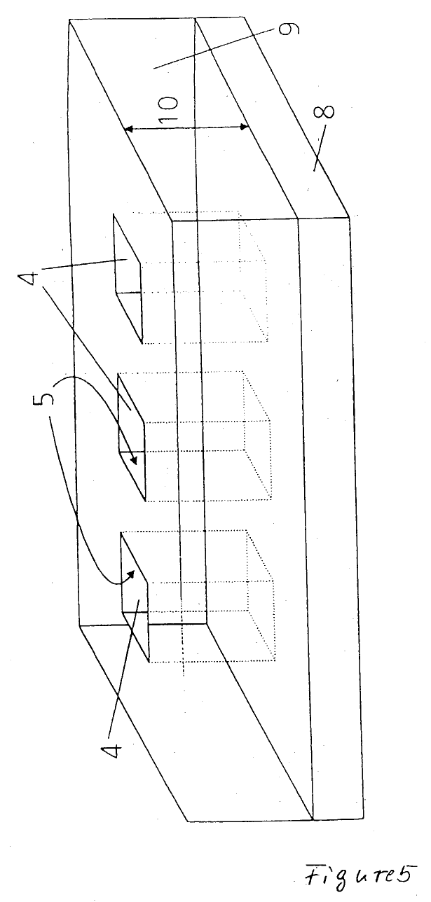

FIG. 4 shows a modified example of a sensor element according to FIG. 3;

FIG. 5 shows a second example of a sensor element according to the invention;

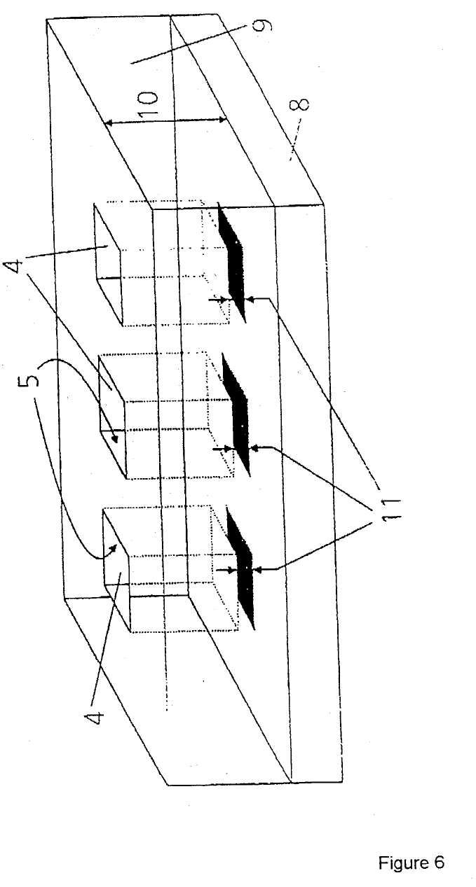

FIG. 6 shows a modified sensor element according to FIG. 5;

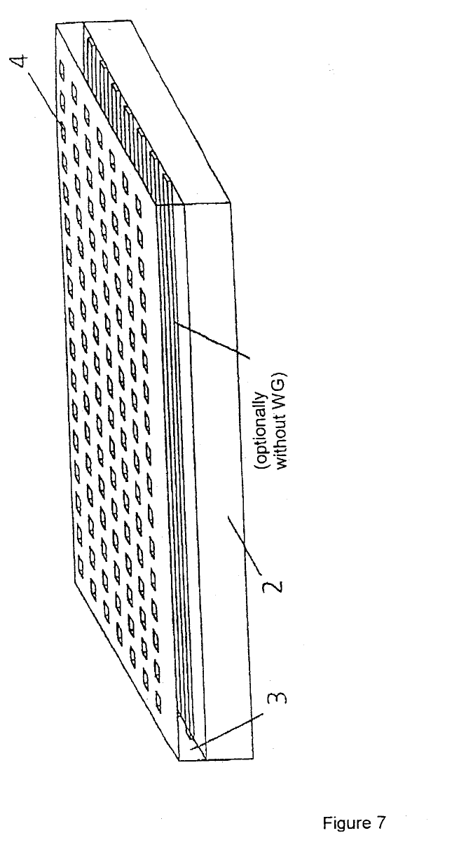

FIG. 7 shows an example of a sensor element with several rows of cavities;

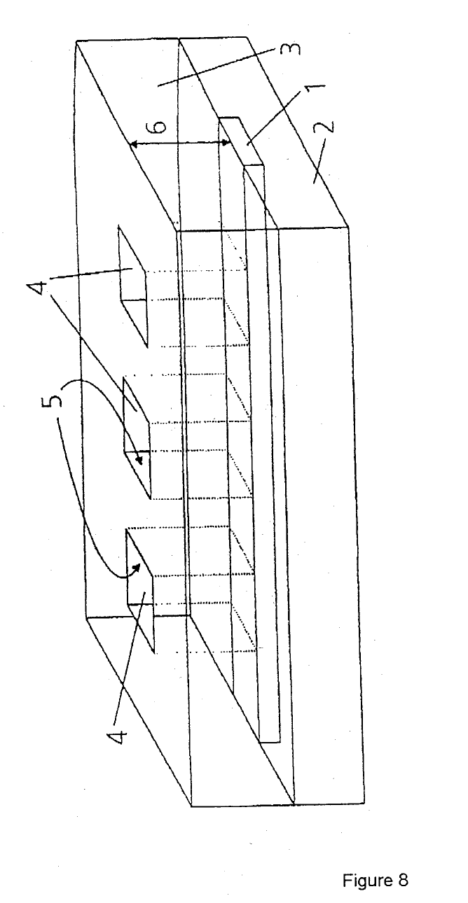

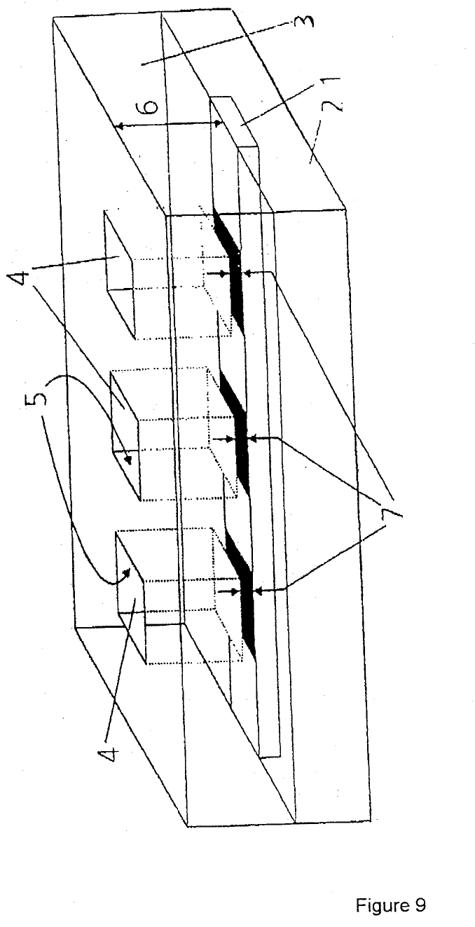

FIG. 8 shows a fourth example of a sensor element according to the invention with a stripline optical waveguide embedded in a substrate;

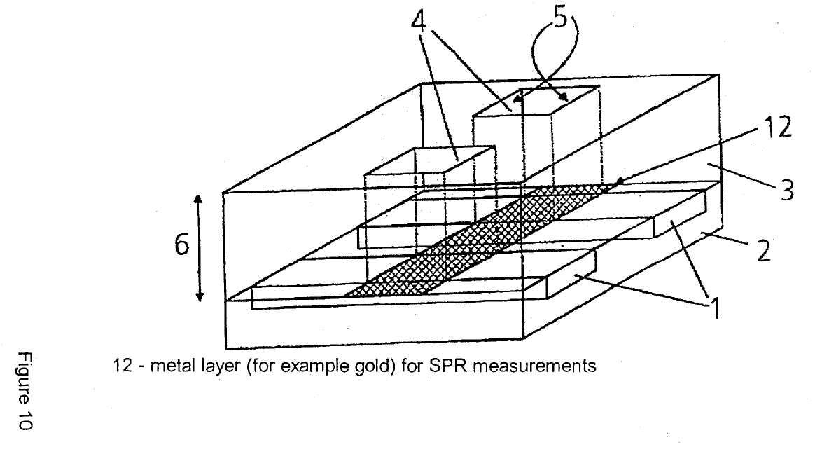

FIG. 9 shows an example which is modified with respect to the example shown in FIG. 8;

FIG. 10 shows an example of a sensor element according to the invention for the use of surface plasmon resonance;

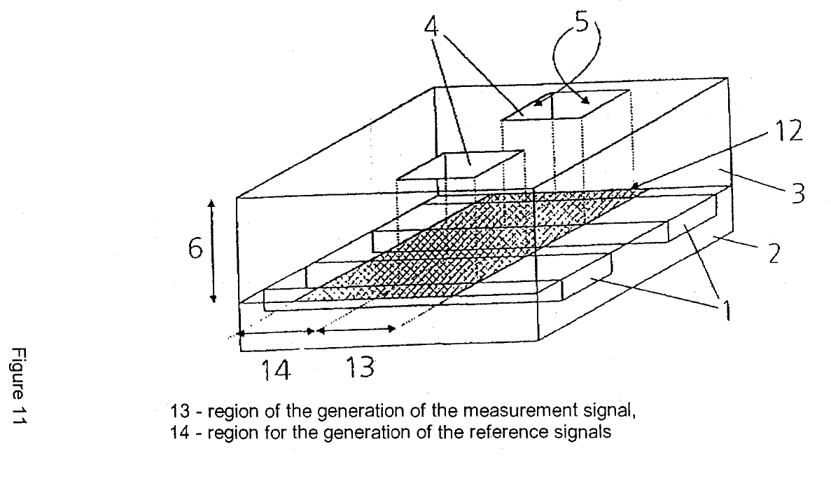

FIG. 11 shows an example, which is modified with respect to the example shown in FIG. 10, of a sensor element according to the invention and

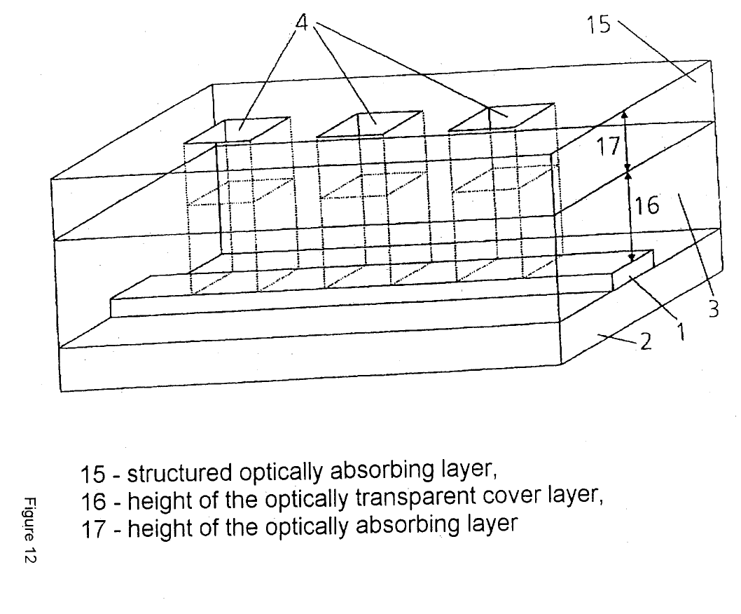

FIG. 12 shows a further example of a sensor element with an additional absorbing layer.

FIG. 1 schematically represents how structured immobilization is intended to be achieved by using hydrophobic long-chained molecules. In this case, it is indicated that measurement errors from samples that are arranged next to one another and are correspondingly immobilized for the detection of targeted analytes can occur owing to nonspecific adsorption of a target molecule, analyte or target-analyte complex.

FIG. 2 indicates that both substance separation and optical separation by using separating walls 3 between samples arranged separated from one another can be achieved with a correspondingly suitable separating-wall material. In this case, the height 6 of the separating walls 3, starting from a substrate surface, should be at least greater than the penetration depth of the evanescent field, which has been indicated by the dashed line.

FIG. 3 shows a first example of a sensor element according to the invention. In this case, a so-called stripline optical waveguide 1 is arranged or applied on a substrate 2, which may consist of virtually any desired material. The excitation light is injected (in a form which is not shown) into this stripline waveguide 1.

As described in the general part of the description, a cover layer 3 of amorphous fluorinated polymer has been applied above the surface of the substrate 2 and, of course, also of the stripline optical waveguide 1, after which the cavities 4 have been formed by photolithographic and etching methods, the cavities extending directly onto the surface of the stripline optical waveguide 1 in this example. Here as well, the remaining height 6 of the cover layer 3, from the surface of the stripline optical waveguide 1 as far as the upper edge of the cover layer 3, must be greater than the penetration depth of the evanescent field.

The various samples can then be introduced into the cavities 4, and a measurement of the excited fluorescent light of the light emerging, here upward, from the cavities 4 can be carried out with the aid of one or more optical detector/detectors above (not shown here), or interferometric measurements can be carried out by using the light transmitted in the waveguides. The walls 5 of the cavities form an interface between the samples, with the analytes contained therein, and the cover-layer material.

Fluorescence is essentially evaluated vertically. Other measurement quantities, for example phase differences, refractive-index changes, absorption change, can be measured along the waveguides. Phase differences of at least two light signals, which have been obtained from different positions of the sensor element, can then in turn be converted interferometrically into intensity differences and evaluated.

The example shown in FIG. 4 differs from the example according to FIG. 3 merely by the fact that the bottoms of the cavities 4 are arranged at a distance 7 from the surface of the stripline optical waveguide 1, although the distance 7 must be less than the penetration depth of the evanescent field.

In the example of a sensor element according to the invention shown in FIG. 5, optical waveguides are obviated and the substrate 8 must be transparent for excitation light that is used, and it must have a higher refractive index than the material for the structured cover layer 9, so that the excitation light injected into the substrate 8 at the interface with the cover layer 9, at a corresponding angle at which total reflection takes place, can generate an evanescent field above the interface.

Of course, there is also the option that the substrate 8 may undertake the function of a planar optical waveguide, in that total reflection can be achieved with injected excitation light at the interfaces.

The example shown in FIG. 6 differs from the example shown in FIG. 5 merely by the fact that the cavities are arranged at a distance 11 from the surface of the substrate 8. In this case, it should again be ensured that the distance 11 is less than the penetration depth of the evanescent field, but conversely that the height 10 of the structured cover layer 9 is greater than the penetration depth of the evanescent field.

FIG. 7 represents a sensor element in which cavities 4 are present in an arrangement of several rows, aligned mutually parallel, within a structured cover layer 3 which is formed on a substrate 2. In this example, a separate stripline optical waveguide 1 is assigned to each row of cavities 4. There is, however, also the option of obviating these stripline optical waveguides, as in the examples according to FIGS. 5 and 6.

In the examples of sensor elements according to the invention shown in FIGS. 8 and 9, the stripline optical waveguide 1 is not formed on the surface of a substrate 2, but instead it is embedded in the substrate 2, the requirements already mentioned several times with respect to the distances 7 and the height 6 of the cover layer 3 in terms of the penetration depth of the evanescent field again needing to be complied with.

The example shown in FIG. 10 represents a substrate 2 and, here, two stripline optical waveguides 1 arranged mutually parallel, a thin metal layer 12 (for example gold) having been applied to the surface of the stripline optical waveguide 1. A structured cover layer 3 with cavities 4 is again formed on top. If an evanescent field is now generated above the surfaces of the stripline optical waveguides 1 as a result of total reflection, surface plasmons can be excited and it is possible to measure the change of the resonance angle or the change of the resonant wavelength.

In the example shown in FIG. 11, which has been modified with respect to the one according to FIG. 10, the metal layer is subdivided into regions 13 and 14. In this case, the region 13 of the metal layer 12 lies directly underneath the bottoms of the cavities 4, and the region 14 of the metal layer 12 is formed and correspondingly arranged underneath the separating regions of the structured cover layer 3. From the region 14 which is arranged directly above the stripline optical waveguide 1 used for the excitation, reference measurement signals that are unperturbed by the respective samples can be obtained through the transparent structured cover layer 3.

FIG. 12 shows an example of a sensor element according to the invention with an additional absorbing layer. The cover layer thickness 16 must in this case be greater than the penetration depth of the evanescent field.

To that end, it is possible to use a structure of a sensor element according to the invention as was proposed above in the description of FIGS. 3 to 11, although only a structure according to the example of FIG. 3 has been shown here, refined by applying or placing an additional optically absorbing layer 15 on the sensor element. This optically absorbing layer 15 is likewise structured according to the cover layer 3, so that the openings of the cavities 4 and the openings formed in the absorbing layer 15 overlap.

The light emerging from the samples through the openings that are formed in the absorbing layer 15 can be recorded with spatial resolution, while being assigned to the respective samples, by an optical detector or a detector array. In this case, it is possible to reduce the divergence of the light emerging from the cavities 4, and consequently also any mutual perturbation of measurement signals from neighboring samples.

1. A sensor element for optically detecting chemical or biochemical analytes, samples containing analytes being arranged in mutually separated cavities inside an evanescent field, which is formed as a result of total reflection at an interface, characterized in that the cavities (4) are formed inside a structured cover layer (3) applied directly to a substrate (2), the cover layer (3) having a layer thickness (6) at least greater than the penetration depth of the evanescent field and consisting of a fluorinated polymer, and they are mutually separated by the cover-layer material so as to prevent substance exchange of the individual samples.

2. The sensor element as claimed in claim 1, characterized in that the cover layer (3) consists of a material with a refractive index≦1.3.

3. The sensor element as claimed in claim 1 or 2, characterized in that the cover layer consists of an amorphous fluorinated polymer.

4. The sensor element as claimed in one of claims 1 to 3, characterized in that at least one optical waveguide (1) is arranged between the substrate (2) and the bottoms of the cavities (4).

5. The sensor element as claimed in one of claims 1 to 4, characterized in that at least one stripline waveguide (1) is arranged between the substrate (2) and the bottoms of the cavities (4).

6. The sensor element as claimed in one of claims 1 to 5, characterized in that the surface of the optical waveguide/waveguides (1) pointing in the direction of the bottoms of the cavities (4) is coated at least in places with a metal layer (12).

7. The sensor element as claimed in one of claims 1 to 6, characterized in that the cavities (4) are arranged in a row, or in a plurality of rows that are arranged mutually parallel, and a stripline waveguide (1) is assigned to each row.

8. The sensor element as claimed in one of claims 1 to 8, characterized in that an optically absorbing layer (17), in which openings or optically transparent windows assigned locally to the cavities (4) are formed, is arranged above the cover layer (3) or is applied to the cover layer (3).

9. A method for producing a sensor element as claimed in one of claims 1 to 8, characterized in that a cover layer (3) with a layer thickness at least greater than the penetration depth of the evanescent field, and which consists of a fluorinated polymer, is applied directly to a substrate (2) and is photographically structured and etched to form cavities (4).

10. The method as claimed in claim 9, characterized in that an adhesion-promoting molecular layer is applied before the cover layer (3) is applied.

11. The method as claimed in claim 9 or 10, characterized in that the cover layer (3) is applied to the substrate (2) using an immersion method or by spin coating.

12. The method as claimed in one of claims 9 to 11, characterized in that at least one optical waveguide (1) is applied to the substrate (2), or is embedded in the substrate (2), before the cover layer (3) is applied.

13. The method as claimed in one of claims 9 to 12, characterized in that the surface of the optical waveguide/waveguides (1) is coated at least in places with a metal.

14. A method for optically detecting chemical or biochemical analytes with a sensor element as claimed in one of claims 1 to 8, characterized in that an evanescent field is formed at an interface of the substrate (2), or of at least one of optical waveguide (1), by total reflection of injected light;
and light emerging from cavities (4), in which samples containing analytes are held, is detected while being locally assigned to the individual cavities (4).

15. The method as claimed in claim 14, characterized in that the intensity of fluorescent light excited in the respective samples is measured.

16. The method as claimed in claim 14, characterized in that surface plasmon resonance is generated on a metal layer (12) in the evanescent field, and the change of the resonance angle or the change of the wavelength is measured.

17. The method as claimed in claim 14, characterized in that at least two light signals are evaluated interferometrically by converting the phase shift into intensity differences.

18. The method as claimed in one of claims 14 to 17, characterized in that light emerging from the cover layer (3) between the cavities (4) is also detected in order to obtain reference signals.
